(19) United States
(12) Patent Application Publication
(10) Pub. No.: US 2004/0100044 A1
(43) Pub. Date: May 27, 2004

(54) Ski scooter

(76) Inventors: Ray F. Monike, St. Louis, MO (US); Sandra S. Monike, St. Louis, MO (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/302,907

(22) Filed: Nov. 25, 2002

(51) Int. Cl. B62B 13/04

(52) U.S. Cl. 280/14.1

(57) ABSTRACT

A ski scooter having a frame with a pivoting, steering post at its front and a seat tube at its rear. A handlebar is secured atop the steering post and a seat is secured atop the seat tube. A foot-supporting platform is secured atop the frame between the seat tube and the steering post. A forward ski is secured to the bottom of the steering post. A rearward ski is secured to the bottom of the frame beneath the seat. A brake assembly is secured to the frame between the seat and the rearward ski. The brake assembly includes a pair of tool bars positioned on opposite sides of the frame. Each of the tool bars has a forward portion that is pivotally secured to the frame and a rearward portion that extends rearward of the seat tube and, also, extends downwardly and rearwardly from the forward portion. A plow blade is secured to each of the rearward portions.

### FIELD OF THE INVENTION

The present invention relates generally to land vehicles and, more particularly, to occupant-steered, multiple sled-type vehicles.

### BACKGROUND OF THE INVENTION

Numerous gravity-propelled vehicles for carrying occupants down snowy hills have been proposed in the past. Some of these vehicles have included a bicycle-type frame that rides upon a pair of short skis positioned one behind the other. At the front of the frame is a handlebar for steering the forward ski. Positioned behind the handlebar is a seat for comfortably supporting an occupant. Vehicles of this type are not usually provided with brakes, making stopping difficult. To stop a vehicle, an occupant must drag his feet in the snow. If the occupant's boots have too little tread, or the vehicle is traveling too fast, it may be necessary to tip the vehicle fully onto its side to stop and avoid a collision with an obstacle.

The brakes that have been provided have not been particularly successful. The brake actuation pedals have been located in positions that are hard to reach by a vehicle occupant. Also, the implements employed to engage the snow have had surface areas that are too small to generate much stopping power. Finally, the snow-engaging implements have been positioned too far forward, rendering the associated vehicles prone to fishtailing and overturning while stopping. A need presently exists for a ski scooter with an effective braking system.

### SUMMARY OF THE INVENTION

In light of the problems associated with the known gravity-propelled vehicles for carrying seated occupants down snowy hills, it is a principal object of the invention to provide a ski scooter with a brakes that are easy to actuate, have great stopping power, and do not cause fishtailing of the ski scooter under normal braking conditions.

It is another object of the invention to provide a ski scooter of the type described which is intuitive in its operation, requiring minimal training to learn how to use. The scooter is believed to be safe and may be operated effectively by healthy adults and properly supervised children.

It is an object of the invention to provide improved elements and arrangements thereof in a ski scooter for the purposes described which is lightweight in construction, inexpensive to manufacture, and fully dependable in use.

Briefly, the ski scooter in accordance with this invention achieves the intended objects by featuring a frame with a seat at its rear for supporting a user. A rearward ski is secured to the bottom of the frame beneath the seat. A brake assembly is secured to the frame between the seat and the rearward ski. The brake assembly includes a pair of tool bars positioned on opposite sides of the frame. Each of the tool bars has a forward portion that is pivotally secured to the frame and a rearward portion that extends rearward of the seat tube and, also, extends downwardly and rearwardly from the forward portion. A plow blade is secured to each of the rearward portions. In use, the plow blades engage snow and ice rearwardly of the seat (and the center of gravity of a user) thereby maintaining the ski scooter on a straight track during normal stopping conditions.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a ski scooter in accordance with the present invention.

FIG. 2 is an enlarged perspective view of the front portion of the ski scooter of FIG. 1.

FIG. 3 is an enlarged perspective view of the rear portion of the ski scooter.

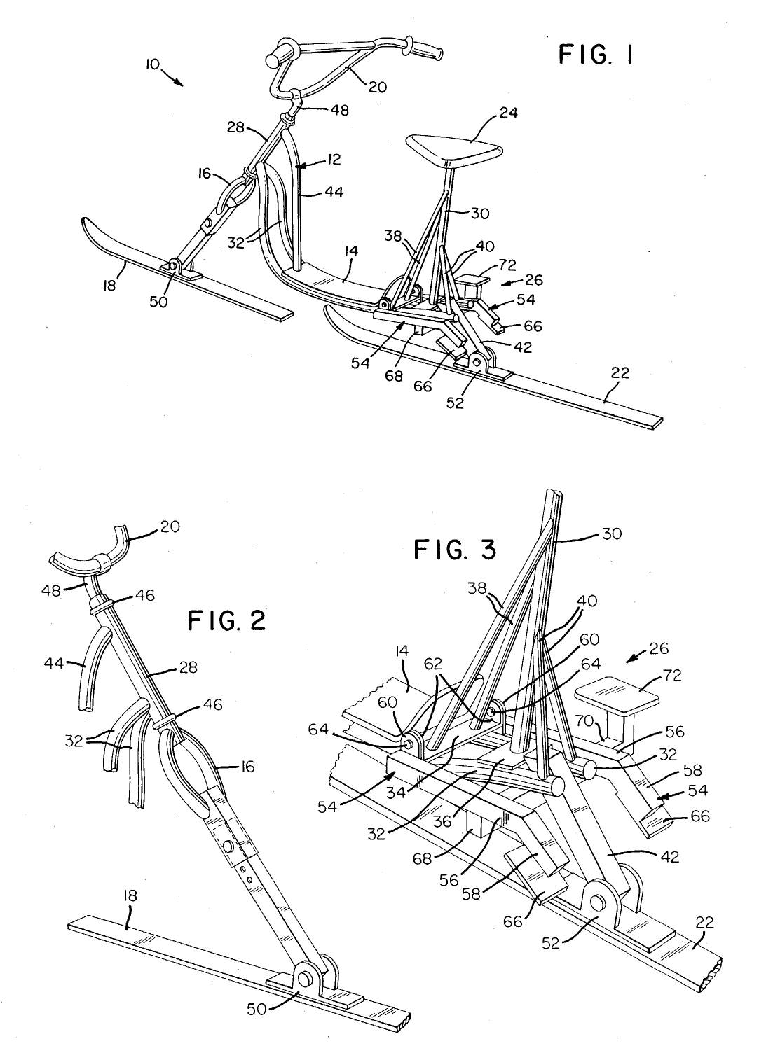

Similar reference characters denote corresponding features consistently throughout the accompanying drawings.

### DETAILED DESCRIPTION OF THE PREFERRED EMBODIMENT

Referring now to the FIGS., a ski scooter in accordance with the present invention is shown at 10. Ski scooter 10 includes a frame 12 carrying a foot-supporting platform 14 and a seat positioned rearwardly of the platform 14. Frame 12 is provided with a steering post 16 at its front end to the bottom of which is secured a forward ski 18 and to the top of which is secured a handlebar 20 for turning post 16 and ski 18. A rearward ski 22 is secured to the rear end of frame 12 beneath a seat 24. A brake assembly 26, positioned below seat 24, permits ski scooter 10 to be safely and easily stopped once in motion on a slick, snowy surface.

Frame 12 has an upright head tube 28 at its front and an upright seat tube 30 at its rear. A pair of down tubes 32 projects downwardly and rearwardly from the bottom of head tube 28. Down tubes 32 are connected together by platform 14 located at their midpoints and a pair of crosspieces 34 and 36 located adjacent their rear ends. Seat tube 30 extends upwardly from rearward crosspiece 36. A pair of forward seat stays 38 extends upwardly from forward crosspiece 34 to the top of seat tube 30. A pair rearward seat stays 40 extend upwardly from the rear ends of down tubes 32 to the midpoints of seat tube 30. Between the rearward seat stays 40, a bottom tube 42 is attached to the rear ends of down tubes 32 and projects downwardly and rearwardly therefrom. A top tube 44 projects downwardly and rearwardly from the top of head tube 28 and is connected to down tubes 32 beneath platform 14.

Steering post 16 is pivotally secured within head tube 28 by headset bearings 46. To the top of post 16 is attached handlebar 20 by means of a stem 48. The bottom of post 16 projects downwardly and forwardly from head tube 28 to a point sufficient to elevate the top and down tubes 44 and 32 above a supporting surface during normal use of ski scooter 10. Forward ski 18 is fastened to the bottom of post 16 by a hinge 50 that permits ski 18 to rock up and down over uneven terrain. Similarly, rearward ski 22 is fastened to the bottom of bottom tube 42 by a hinge 52.

Brake assembly 26 includes a pair of tool bars 54 positioned on opposite sides of frame 12 at the rear end thereof. Each of the tool bars 54 has a forward portion 56 and an angularly attached, rearward portion 58. As shown, rearward portion 58 extends well rearward of seat tube 30. Rearward portion 58 also extends downwardly and rearwardly from forward portion 56 so to increase the angle at which rearward portion 58 encounters snow or ice when rotated downwardly into contact therewith. To permit downward rotation, the front of each forward portion 56 is provided with an upstanding flange 60 adapted for positioning adjacent one of a pair of mounting flanges 62 respectively positioned at opposite ends of crosspiece 34. A pair of pivot pins 64 pivotally connects adjacent flanges 60 and 62 together.

Plow blades 66 are affixed to the bottom surfaces of the rearward portions 58 of tool bars 54. Each of blades 66 is a flat plate that presses against snow when pivoted downwardly. However, because the length of each tool bar 54 is greater than the shortest distance from the center of pivot pins 64 to the bottom of rearward ski 22, blades 66 maintain something of a positive angle of attack when pivoted to their lowermost position so that they can readily climb over snow-buried obstacles like tree roots and rocks. Thus, the likelihood of ski scooter 10 coming to a sudden stop and throwing a rider during a hang-up on an obstacle is minimized.

The forward portions 56 of tool bars 54 are rigidly connected together by a tie bar 68 in an H-shaped configuration. Tie bar 68 extends outwardly away from one of tool bars 54 so as to be provided with a lateral extension 70. A brake pedal 72 is secured to the distal end of extension 70. Because tie bar 68 passes beneath down tubes32, a user of ski caddy 10 can easily accomplish the dual rotation of tool bars 54 merely by pushing downwardly on brake pedal 72 with his foot. Since pedal 72 is located away from the centerline of frame 12, pedal 72 can be located with minimal effort in a spot that falls naturally below one leg of a user.

Numerous means may be employed to retain tool bars 54 and tie bar 68 in an elevated position when it is not desired that they be deployed to stop ski scooter 10. For example, an elastomeric cord or band (not shown) could be extended from seat 24 downwardly to one of the bars 54 or 68. On the other hand, a coiled spring (not shown) could be extended between crosspiece 36 and one of bars 54 or 68. Of course, bars 54 need not be retained in any manner and can be permitted to rest directly upon a snowy surface for the application of immediate stopping power.

Use of ski bike 10 is straightforward. First, ski scooter 10 is brought to the top of a snowy hill. Then, a user positions himself atop seat 24 and grasps handlebar 20. Next, the user positions his right foot atop brake pedal 72 to drive plow blades 66 into the snow to initially anchor ski scooter 10 in place. Finally, when ready, the user positions both feet on platform 14 thereby permitting ski scooter 10 to coast downhill. To maneuver to the bottom of the hill, handlebar 20 is turned as desired. At any point, the user may press brake pedal 72 downwardly again to slow or stop ski scooter 10. Thus, the direction and speed of ski scooter 10 are controlled at all times. The user proceeds in complete safety.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

We claim:

1. A ski scooter, comprising:
a frame having a steering post at the front thereof and an upright seat tube at the rear thereof;
a handlebar secured to the top of said steering post;
a seat secured atop said seat tube;
a foot-supporting platform secured atop said frame between said seat tube and said steering post;
a forward ski secured to the bottom of said steering post;
a rearward ski secured to the bottom of said frame beneath said seat;
a brake assembly secured to said frame between said seat and said rearward ski, said brake assembly including:
a pair of tool bars positioned on opposite sides of said frame, each of the tool bars having a forward portion that is pivotally secured to said frame and a rearward portion that extends rearward of said seat tube and also extends downwardly and rearwardly from said forward portion; and,
a pair of plow blades, each of said blade being respectively secured to one of said rearward portions.
